(19) United States
(12) Patent Application Publication
(10) Pub. No.: US 2026/0044660 A1
(43) Pub. Date: Feb. 12, 2026

(54) PRINTED CIRCUIT BOARD COMPONENT PLACEMENT

(71) Applicant: NVIDIA Corporation, Santa Clara, CA (US)

(72) Inventors: Anthony Dimitri Armand Agnesina, Atlanta, GA (US); Haoxing Ren, Austin, TX (US); Niansong Zhang, San Jose, CA (US)

(21) Appl. No.: 19/053,060

(22) Filed: Feb. 13, 2025

Related U.S. Application Data
(60) Provisional application No. 63/682,164, filed on Aug. 12, 2024.

(51) Int. Cl. G06F 30/392; G06F 30/398; G06F 111/10; G06F 115/12

(52) U.S. Cl. CPC G06F 30/392; G06F 30/398; G06F 2111/10; G06F 2115/12

(57) ABSTRACT

A scalable, GPU-accelerated printed circuit board (PCB) placement process can utilize various cost factors to determine placement on the PCB. The cost factors can include the wirelength parameter, the net crossing parameter, the routability parameter, or the density parameter. Other factors can be utilized as well. The cost factor algorithm can be used to design a PCB placement using the desired optimizations. The processes can utilize a two-sided PCB, and rotation or orientation of each component design. The processes are scalability for large commercial designs maintaining the desired operating times and optimizations constraints. A synthesized benchmark suite to support tool comparisons and track progress is disclosed.

### CROSS-REFERENCE TO RELATED APPLICATION

This application claims the benefit of U.S. Provisional Application Ser. No. 63/682,164, filed by Agnesina, et al., on Aug. 12, 2024, entitled “SCALABLE GPU-ACCELERATED PCB PLACEMENT,” commonly assigned with this application and incorporated herein by reference in its entirety.

### TECHNICAL FIELD

This application is directed, in general, to designing a printed circuit board and, more specifically, to using objective optimization techniques to determine where to place components on the printed circuit board.

### BACKGROUND

The scale of printed circuit board (PCB) designs has increased significantly, with modern commercial designs featuring more than 10,000 components. The placement process heavily relies on manual efforts that take weeks to complete, highlighting the need for automated PCB placement methods. The challenges of PCB placement arise from its flexible design space and limited routing resources. Existing automated PCB placement tools have achieved limited success in quality and scalability.

### SUMMARY

In one aspect, a method is disclosed. In one embodiment the method includes (1) receiving a set of component designs to be arranged on a printed circuit board (PCB), wherein each component design in the set of component designs is an electronic component that is intended to be electrically coupled to at least one other component in the set of component designs and includes a count of pins for the component, (2) designating a placement for each component design in the set of component designs on the PCB using an iterative cost function to generate a PCB design, wherein the iterative cost function includes (2a) determining a wire path between each pin of each component design in the set of component designs and a corresponding electrically coupled pin of a different component in the set of component designs using a coupling policy received as input parameters, (2b) calculating a half-perimeter wirelength (HPWL) parameter for the set of component designs, (2c) calculating a net crossing (NC) parameter for the set of component designs, (2d) calculating a density parameter for the set of component designs, and (2e) evaluating the iterative cost function using the HPWL parameter, the NC parameter, and the density parameter, wherein the iterative cost function ends at a time specified by an end parameter received with the input parameters or when a result of the iterative cost function satisfies a design threshold parameter, wherein the design threshold parameter is received in the input parameters.

In a second aspect, a system is disclosed. In one embodiment, the system includes (1) a component placement system capable to designate a placement of each component design in a set of component designs using an iterative cost function to generate a PCB design, wherein the iterative cost function determines a wire path between each pin of each component design in the set of component designs and an intended corresponding electrically coupled pin of a different component in the set of component designs using a coupling policy received as input parameters, calculates a half-perimeter wirelength parameter (HPWL) for the set of component designs, calculates a net crossing parameter (NC) for the set of component designs, calculates a density parameter for the set of component designs, and evaluates the iterative cost function using the HPWL parameter, the NC parameter, and the density parameter, where the iterative cost function ends at a time specified by an end parameter received with the input parameters or when a result of the iterative cost function satisfies a design threshold parameter, and (2) a benchmark system capable to evaluate the PCB design using an evaluation tool to generate a design efficiency parameter, wherein the designate a placement for each component design is repeated when the design efficiency parameter fails to meet the design threshold.

In a third aspect, a non-transitory computer program product having a series of operating instructions stored on a non-transitory computer-readable medium that directs a PCB design process when executed thereby to perform operations is disclosed. In one embodiment, the operations include (1) receiving a set of component designs to be arranged on a printed circuit board (PCB), wherein each component design in the set of component designs is an electronic component that is intended to be electrically coupled to at least one other component in the set of component designs and includes a count of pins for the component, (2) designating a placement for each component design in the set of component designs on the PCB using an iterative cost function to generate a PCB design, wherein the iterative cost function includes, (2a) determining a wire path between each pin of each component design in the set of component designs and a corresponding electrically coupled pin of a different component in the set of component designs using a coupling policy received as input parameters, (2b) calculating a half-perimeter wirelength parameter (HPWL) for the set of component designs, (2c) calculating a net crossing parameter (NC) for the set of component designs, (2d) calculating a density parameter for the set of component designs, and (2e) evaluating the iterative cost function using the HPWL parameter, the NC parameter, and the density parameter, wherein the iterative cost function ends at a time specified by an end parameter received with the input parameters or when a result of the iterative cost function satisfies a design threshold parameter, wherein the design threshold parameter is received in the input parameters, and (3) manufacturing the PCB using the PCB design.

In a fourth aspect, a processing unit is disclosed. In one embodiment, the processing unit includes (1) a PCB design system, capable of designating a placement of each component design in a set of component designs using an iterative cost function to generate a PCB design, wherein the iterative cost function determines a wire path between each pin of each component design in the set of component designs and an intended corresponding electrically coupled pin of a different component in the set of component designs using a coupling policy received as input parameters, calculates a half-perimeter wirelength parameter (HPWL) for the set of component designs, calculates a net crossing parameter (NC) for the set of component designs, calculates a density parameter for the set of component designs, and evaluates the iterative cost function using the HPWL parameter, the NC parameter, and the density parameter, where the iterative cost function ends at a time specified by an end parameter received with the input parameters or when a result of the iterative cost function satisfies a design threshold parameter, and (2) a benchmark system, capable of evaluating the PCB design using an evaluation tool to generate a design efficiency parameter, wherein the designating a placement for each component design is repeated when the design efficiency parameter fails to meet the design threshold.

### BRIEF DESCRIPTION

Reference is now made to the following descriptions taken in conjunction with the accompanying drawings, in which:

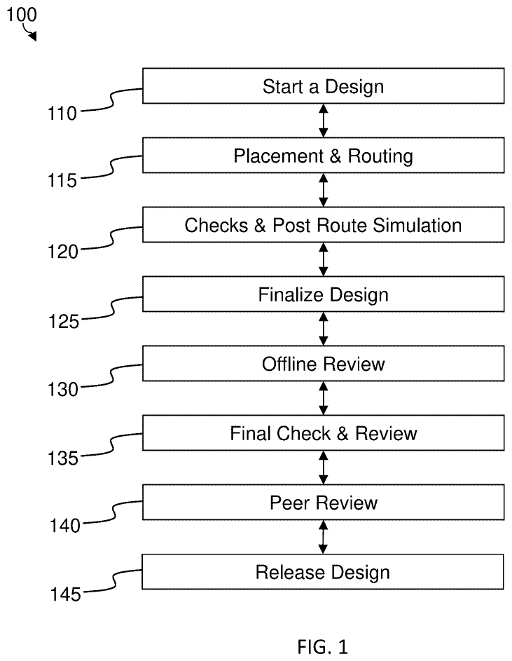

FIG. 1 is an illustration of a diagram of example flow to design a PCB;

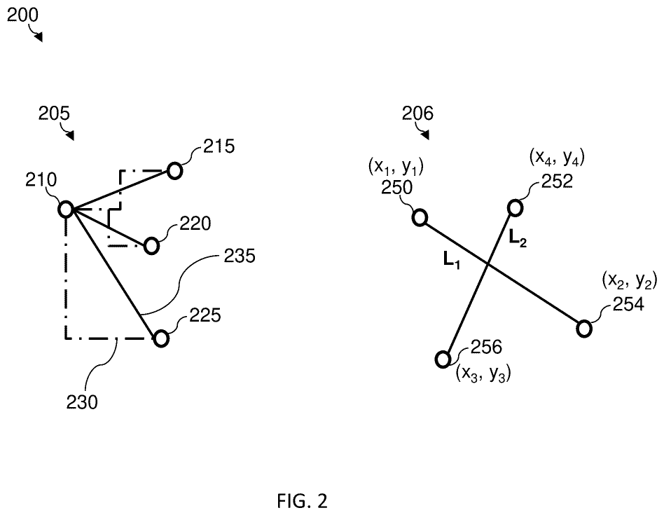

FIG. 2 is an illustration of a diagram of example net crossing;

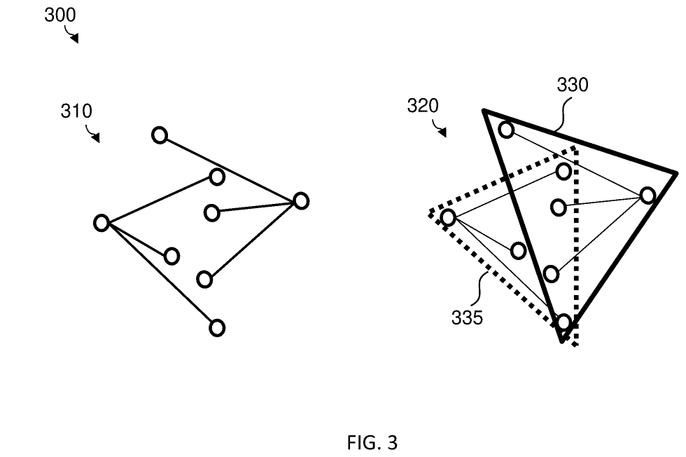

FIG. 3 is an illustration of a diagram of an example net convex model;

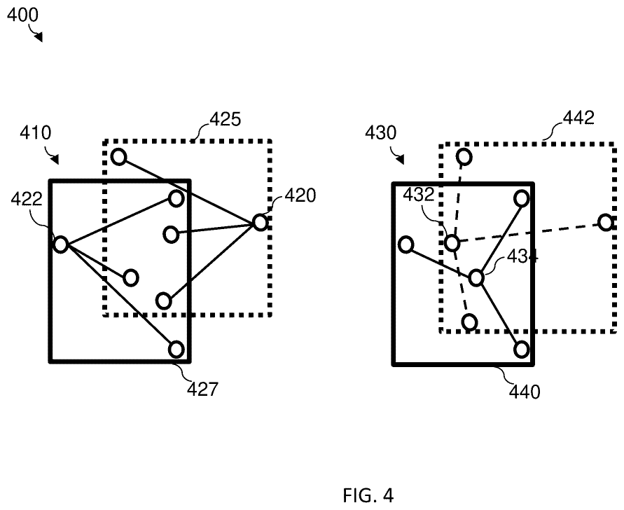

FIG. 4 is an illustration of a diagram of an example of a VLSI placement model;

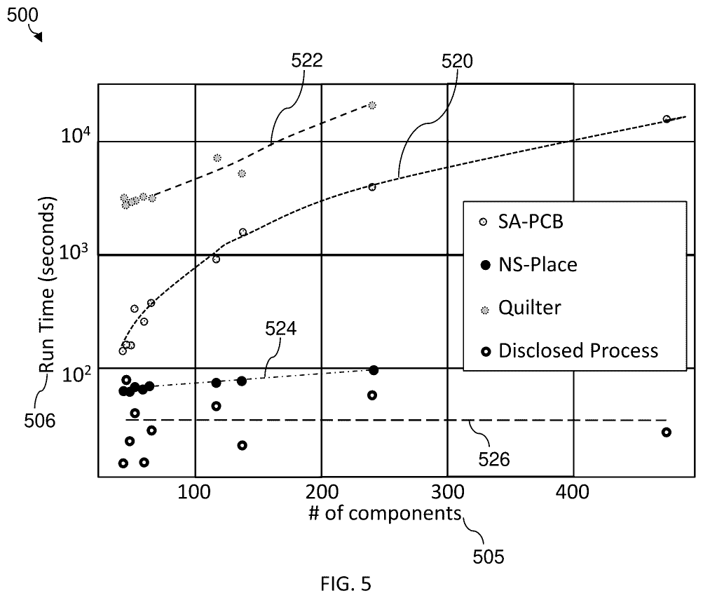

FIG. 5 is an illustration of a diagram of an example graph showing a relative scalability performance of the disclosed processes and selected industry tools;

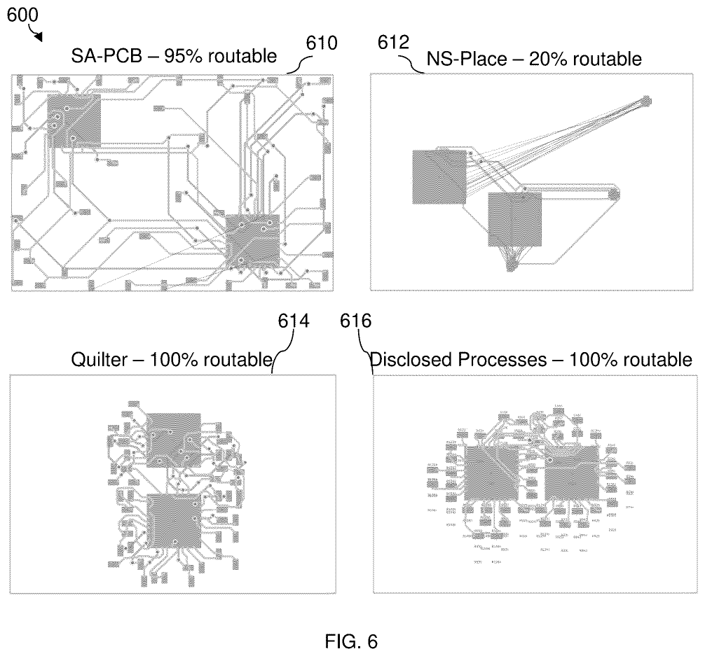

FIG. 6 is an illustration of a diagram of example design solutions produced by the tested tools;

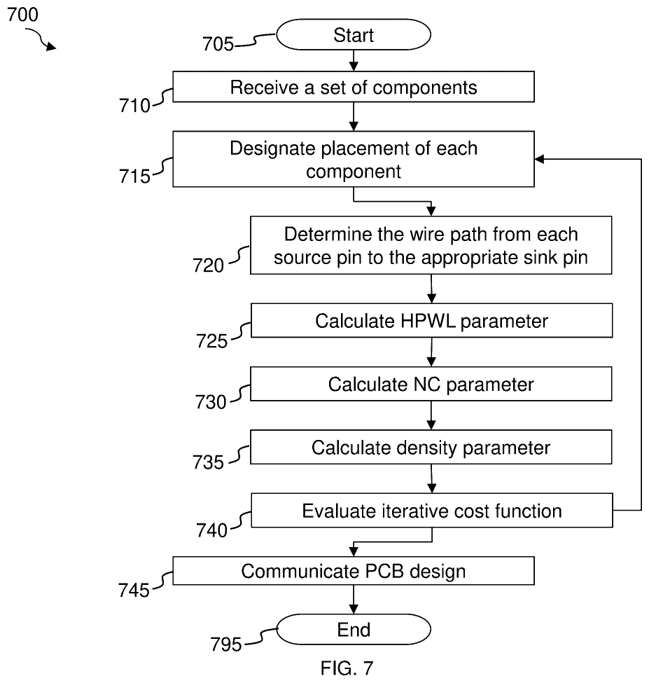

FIG. 7 is an illustration of a flow diagram of an example method to use a PCB design process;

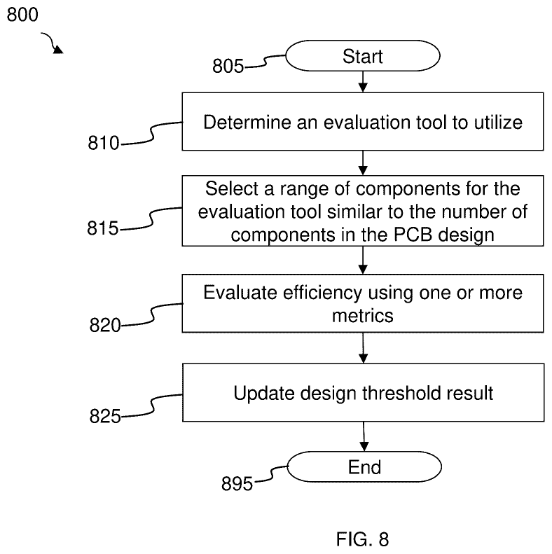

FIG. 8 is an illustration of a flow diagram of an example method to evaluate a PCB design;

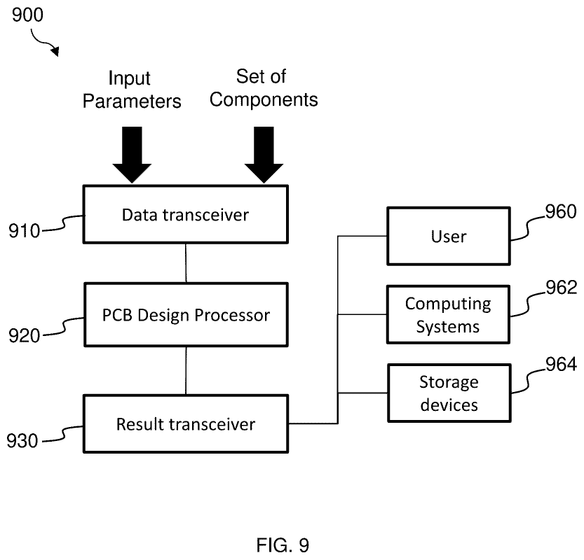

FIG. 9 is an illustration of a block diagram of an example PCB design system; and

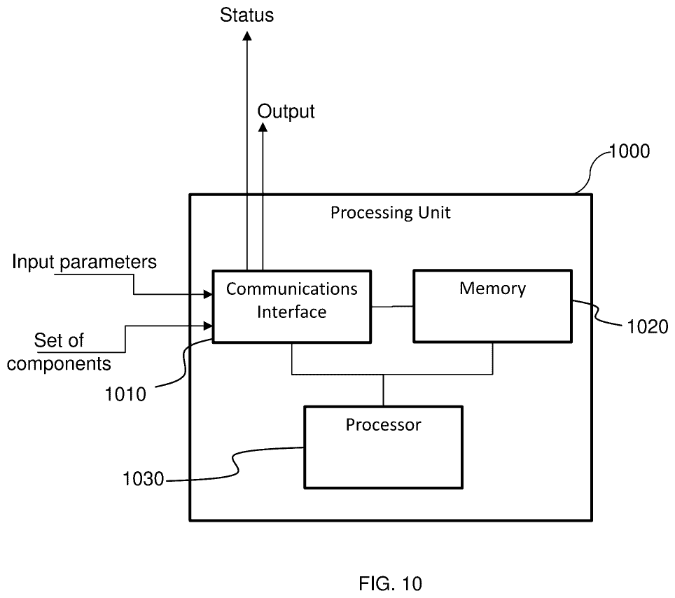

FIG. 10 is an illustration of a block diagram of an example of a PCB design controller according to the principles of the disclosure.

### DETAILED DESCRIPTION

Printed circuit board (PCB) placement and routing (PnR) are typically carried out manually by PCB layout engineers. With the increasing integration density and scale of PCB design, this manual process takes many weeks. Approximately 50% of the total PCB design time is spent on component placement, making it a significant bottleneck in the design process. In the modern commercial PCB design process, the workflow begins with schematic capture, where engineers create a circuit diagram that defines the electrical connections between components. Then follows part selection, where suitable components are chosen based on performance, cost, and availability. The design is then translated into a netlist, a data structure that lists the connections between components. After the schematic is complete, the physical design phase begins. Here, components are placed on the PCB layout, and their positions should satisfy a variety of constraints, including electrical performance, signal integrity, thermal management, and mechanical considerations.

Once the initial layout is completed, the design undergoes routing, where traces are drawn to connect the components according to the netlist. This is followed by design rule checks (DRCs) to ensure that the layout adheres to manufacturing requirements and standards. Throughout the process, the design should go through multiple rounds of peer review and verification to address potential issues related to signal integrity, power delivery, and thermal performance. A key bottleneck in this flow is the placement phase, which can consume around 50% of the overall design time. Optimizing component placement is critical as it directly impacts the ease of routing, overall performance, and manufacturability of the PCB.

PCB placement tools are not widely used. Existing PCB placement tools struggle with large-scale designs and achieve limited placement quality. For example, the state-of-the-art commercial PCB PnR solution, Quilter, takes 2.6 hours to layout a design with 176 components, and RePlace fails to find a routable placement for multilayer PCB designs with components of diverse sizes.

The challenge of PCB PnR lies in its complex design space and limited routing resources. Unlike very large-scale integration (VLSI), PCB placement has a flexible design space with diverse-sized components that can be rotated and placed on each side of the board. The shape of the PCB board and the components are often irregular. VLSI routing utilizes rectilinear single nets with many small vias across numerous routing layers, while PCBs employ bus-level traces that allow greater freedom in angles while typically use fewer routing layers. VLSI placement methods are widely used in standard cell integrated circuit (IC) designs and mixed-size system-on-chip (SoC) designs. Analytical methods such as mPL6, NTUPlace, ePlace, formulate placement as a mathematical optimization problem. DREAMPlace-based methods leverage gradient descent, modern machine learning optimizers, and GPU acceleration to accelerate placement and improve solution quality. These VLSI placement algorithms have been proven to be scalable for designs with millions of cells and deliver high-quality results.

Disclosed are processes that describe a PCB placement approach using tailored cost functions, constraint handling, and optimization techniques to improve design quality and scalability. Although VLSI-inspired methods enhance scalability and placement quality, there is no single solution for PCB placement. Critical components, such as those for high-current or high-speed signals, often need careful manual placement and routing. The disclosed processes focus on a fast placement routine for noncritical components, helping designers accelerate the iterative process needed to meet performance requirements and design constraints.

There is a lack of high-quality benchmarks for the PCB placement problem. To enable meaningful comparisons between tools and establish a performance baseline, an open-source PCB placement benchmark is disclosed consisting of ten synthesized designs with noncritical components. These benchmarks can be derived from commercial PCB designs and insight into how engineers approach manual PCB layout.

In some aspects, the processes can include a tailored cost function for PCB placement. The processes introduce a novel problem formulation tailored specifically for PCB placement, incorporating one or more of an orientation-aware wirelength (WL) parameter, a density parameter, and a net crossing (NC) parameter. This formulation can improve the accuracy of evaluations and optimizations in real-world scenarios.

In some aspects, the processes can include scalability functions. Evaluation results demonstrate that a runtime improvement over current state of the art solutions can be achieved, with the improvement increasing as the number of components increases.

In some aspects, an open-source benchmark can be used. A synthesized PCB placement benchmark based on real PCB designs as well as related tools to visualize and interface with commercial and open-source electronic design automation tools can be used to determine the efficiency of the PCB design.

In some aspects, evaluation of the PCB design can be compared to real commercial designs. The disclosed processes can be evaluated on industrial PCB designs with thousands of components. These tests can confirm the practicality and effectiveness of the disclosed processes across various sizes and complexities of PCB designs.

The disclosed processes utilize a framework that can model PCB placement as a multi-objective optimization problem, solved through a gradient descent approach. To optimize for routability, PCB-specific cost functions tailored to the problem's constraints can be used. In addition, the framework can employ Bayesian optimization to effectively explore the parameter space, leading to improved solution quality. The notations used are listed in Table 1.

TABLE 1
Example Notations Used

| Notation | Description | Notation | Description |
|---|---|---|---|
| E | Set of nets | x, y | Components center |
| | | | locations |
| θ | Components | Θ | Set of legal |
| | orientations | | orientations |
| c | Component c | (x_{c}, y_{c}, θ_{c}) | Centoer location/ |
| | | | orientation of c |
| vₖ | Pin k | (xₖ^{off}, yₖ^{off}) | Offsets of vₖ from |
| | | | (x_{c}, y_{c}) |
| WL, NC | Wirelength, net | D | Density |
| | crossing | | |
| λ_{D} | Density weight | λ_{NC} | Net crossing weight |
| P_{x, y} | Preconditioner | P_{π} | Preconditioner for |
| | for x, y | | orientation |

The processes focus on placing surface-mounted, noncritical components on a rectilinear PCB's top and bottom layers, i.e., sides. The framework can take a PCB netlist with pre-assigned layers as input. In some aspects, components, such as mechanical or high-speed, high-current critical elements, can be fixed in place. In some aspects, pre-routed high-speed traces can be included as placement blockages. Components can be various shapes and can be placed in various locations on the assigned layer as long as the components meet spacing constraints. The outcome can be to assign each component design c a coordinate (x_{c}, y_{c}) and a legal orientation θ_{c} to maximize a routability parameter. While routability is an important goal of PCB placement, it can be realized through optimizing the multiple proxies presented later, e.g., a wirelength parameter, a net crossing parameter, and a density parameter.

PCB placement differs from mixed-size VLSI placement in several ways. First, PCB components can be placed anywhere on a layer, unlike standard cell placement in VLSI, which is constrained by fixed rows and sites. Second, PCBs have far fewer routing resources. While VLSI benefits from multiple stacked metal layers, often making routing a three-dimensional (3D) problem, PCB routing is restricted to a more limited two-dimensional (2D) space, making it more difficult to route crossing nets. Finally, PCB components can rotate to any legal orientation, a flexibility not typically considered in VLSI placement.

To address the challenge of limited routing resources in PCBs, a metric can be defined called a net crossing parameter to capture routing conflicts on the same copper layer. Each multi-pin net can be decomposed into a set of pin pairs. Each pair connects the source pin to one of the sink pins with a line segment. This can mimic how PCB signals are routed. A crossing score can then be defined between two-line segments.

As an example, the crossing for a pair of line segments L1 and L2 can be defined. First, L1 and L2 can be expressed in the first degree Bézier form as shown in Equation 1.

$$Example Bézier form$$

$${L}_{1} = [ \frac{{x}_{1}}{{y}_{1}} ] + t [ \frac{{x}_{2} - {x}_{1}}{{y}_{2} - {y}_{1}} ] \qquad Equation 1$$

$${L}_{2} = [ \frac{{x}_{3}}{{y}_{3}} ] + u [ \frac{{x}_{4} - {x}_{3}}{{y}_{4} - {y}_{3}} ]$$

where (xᵢ, yᵢ) is the coordinate of pin vᵢ, t and u are Bézier parameters defined in Equation 2.

$$Example Bézier parameters$$

$$t = \frac{( {x}_{1} - {x}_{3} ) ( {y}_{3} - {y}_{4} ) - ( {y}_{1} - {y}_{3} ) ( {x}_{3} - {x}_{4} )}{( {x}_{1} - {x}_{2} ) ( {y}_{3} - {y}_{4} ) - ( {y}_{1} - {y}_{2} ) ( {x}_{3} - {x}_{4} ) + ϵ} \qquad Equation 2$$

$$u = \frac{( {x}_{1} - {x}_{2} ) ( {y}_{1} - {y}_{3} ) - ( {y}_{1} - {y}_{2} ) ( {x}_{1} - {x}_{3} )}{( {x}_{1} - {x}_{2} ) ( {y}_{3} - {y}_{4} ) - ( {y}_{1} - {y}_{2} ) ( {x}_{3} - {x}_{4} ) + ϵ}$$

where ϵ is a small value to prevent division by zero, such as when L₁ and L₂ are parallel.

There is an intersection of L₁ and L₂ if 0≤t≤1 and 0≤u≤1 simultaneously. A bell-shaped function can be applied, for example, similar to a density function to obtain a smooth cost function, such as shown in Equation 4.

$$Example smooth cost function$$

$$Crossing ( {L}_{1} , {L}_{2} ) = B ( t - 0.5 ) B ( u - 0.5 ) \qquad Equation 4$$

where B is a bell-shaped function defined in Equation 5.

$$Example bell - shaped function$$

$$B ( x ) = \{ \begin{matrix}1 - {vx}^{2} , & 0 \leq \vert x \vert \leq 0.5 \\ {μ ( \vert x \vert - σ )}^{2} , & 0.5 \leq \vert x \vert \leq 1 \\ 0 , & \vert x \vert \geq 1\end{matrix} \qquad Equation 5$$

where v, y, and σ are tunable parameters subject to 1−0.25v=μ(0.5−σ)².

The cost as described in Equation 4 can be positive when segments cross, serving as a penalty. The NC for the entire design is the sum of the crossings between the pairs of line segments, i.e., NC=Σ_{(i,j)}Crossing(Lᵢ,Lⱼ). This can be computed in parallel with GPUs despite the quadratic complexity, given the small number of nets of PCBs.

Given PCB components' large and diverse sizes, their orientations can impact placement quality, especially in terms of WL. In some aspects, the differentiable log-sum-exp (LSE) wirelength model can be extended to consider permissible orientation parameter of at least one component. WL(x, y, θ) can be the total wirelength for nets with components rotations θ considered as shown in Equation 6.

$$Example WL computation$$

$$WL ( x , y , θ ) = {\sum }_{e ∈ E} γ ( log {\sum }_{{v}_{k} ∈ e} exp ( \frac{{x}_{k}}{γ} ) + log {\sum }_{{v}_{k} ∈ e} exp ( - \frac{{x}_{k}}{γ} ) + log {\sum }_{{v}_{k} ∈ e} exp ( \frac{{y}_{k}}{γ} ) + log {\sum }_{{v}_{k} ∈ e} exp ( - \frac{{y}_{k}}{γ} ) ) \qquad Equation 6$$

where (xₖ, yₖ) is the coordinate of pin vₖ as shown in Equations 7.

$$Example pin coordinates$$

$${x}_{k} = {x}_{c} + {x}_{k}^{off} cos {θ}_{c} - {y}_{k}^{off} sin {θ}_{c} \qquad Equation 7$$

$${y}_{k} = {y}_{c} + {x}_{k}^{off} sin {θ}_{c} - {y}_{k}^{off} cos {θ}_{c} where {θ}_{c} ∈ Θ .$$

Parameter γ is a smoothness parameter that can control the WL approximation accuracy. Designating a placement for each component design can be repeated using different independent and identically distributed random values when determining a relaxation of a permissible orientation of at least one component in the set of component designs. To make the orientation continuous, the categorical choice of a permissible, i.e., legal, orientation can be relaxed to a softmax function over legal orientations θ_{c}∈Θ, as shown in Equation 8.

$$Example relaxation of permissible ( legal ) orientations$$

$${\hat{θ}}_{c} = \frac{exp ( \frac{( log ( {π}_{i} ) + {g}_{i} )}{τ} )}{{\sum }_{j = 1}^{k} exp ( \frac{( log ( {π}_{j} ) + {g}_{j} )}{τ} )} , for i = 1 , … , \vert Θ \vert \qquad Equation 8$$

where gᵢ are independent and identically distributed random variables (iid) derived from a Gumbel distribution (0,1),
τ is the softmax temperature parameter.

The task of choosing a legal orientation can be relaxed to learn the continuous class probability π. The legal orientation choice can be obtained as θ_{c}=argmax[gᵢ+log πᵢ]. Ensuring legal orientations are used when computing the WL and density can minimize the miscorrelation with the true legal placement, compared with any continuous rotation angle. The orientations can affect the net crossing score, given it modifies the pin locations.

After the continuous relaxation for orientation, the optimization problem becomes jointly optimizing the component coordinates (x, y) and the component orientations θ. Analogous to neural architecture search using gradient descent, a bilevel optimization process can be applied, as described in Algorithm 1.

### Algorithm 1: Example Bilevel Placement Optimization

1. Create an initial placement parameterized by (x, y, π)
2. Obtain the global placement loss functions [symbol] defined in Equation 9
3. While not converged do
   a. Update positions x, y by descending ∇ [symbol] while freezing π, using P_{x,y} as the gradient preconditioner [symbol]
   b. Update class probabilities ∇ [symbol] by descending while freezing x, y, using Pₙ as the gradient preconditioner
4. Derive final placement (x, y, π)
5. Legalize placement

The disclosed processes can use the density model as described in the DREAMPlace model which models components as electric charges, density as potential energy, and density gradient as electric field. The electric potential and field distribution is obtained by solving Poisson's equation from the charge density distribution via spectral methods with a 2D fast Fourier transform (FFT). Density is defined as D(x,y,θ). Modifications are made to the model to enable PCB domain specificities. The inclusion of θ remains consistent with the DREAMPlace model, as components are first rotated, which potentially swaps the height and width of a component when calculating the density map. The two-sided nature of PCBs are accounted for by constructing separate density maps for each side, leading to an accurate representation of the overall density. The side assigned to each component design can be pre-determined by the designer's choice.

Equation 9 represents combined cost function including WL, NC, and density weighting.

$$Example combined cost function$$

$$ℒ ( x , y , θ ) = WL ( x , y , θ ) + {λ}_{D} D ( x , y , θ ) + {λ}_{NC} NC ( x , y , θ ) \qquad Equation 9$$

where λ_{D} is the weight of the density parameters, and
   λ_{NC} is the weight of the net crossing parameter.

At the beginning of the placement process, the components can be positioned at an initial starting point, minimizing wirelength due to overlap. The Lagrange multiplier λ_{D} can be progressively increased for the density term to spread the components and reach a minimal energy state at the end of global placement. A dynamic density schedule can be used, where the density weight can be exponentially increased, controlled by a density factor bounded within predefined lower and upper limits. The weight of the net crossing term, λ_{NC}, can be gradually increased to reduce net crossings as components are distributed. A static linear schedule for the net crossing weight can be used, such as

$${η}_{NC}^{t + 1} = {λ}_{NC}^{t} + η ,$$

with η being a tunable parameter.

Varying sizes of PCB components can lead to slow convergence or even divergence during optimization. In some aspects, the disclosed processes can apply divergence-aware gradient preconditioning. The second-order derivative of the wirelength objective is estimated based on the pin count of each component design, while the second-order derivative of the density term is approximated by the component area, forming the diagonal of the Hessian matrix. In some aspects, no preconditioning term was needed for the net crossing, given that the wirelength preconditioning term can account for it. The precondition operator for updating the positions x, y is shown in Equation 10.

$$Example reconditioning algorithm$$

$$\begin{matrix}{P}_{x , y} = min ( 1 , {( {∇}^{2} WL ( x , y , θ ) + {βλ}_{D} {∇}^{2} D ( x , y , θ ) )}^{- 1} ) \\ = min ( 1 , {( \#pin ( c ) + {βλ}_{D} area ( c ) )}^{- 1} )\end{matrix} \qquad Equation 10$$

where #pin ( ) is the number of pins of a component, and
   area( ) is the area of the component.

Term β is initialized to 1 and linearly increased with each iteration. This gradual increase in β reduces the movement of larger components in the later stages of the optimization process. In some aspects, for orientation updates, since class probabilities are updated by gradients from wirelength and net crossings, the second term of the preconditioning operation for the density calculation can be omitted, as shown in Equation 11.

$$Example reconditioning while avoiding using the density calculation$$

$${P}_{π} = min ( 1 , \#pin {( c )}^{- 1} ) \qquad Equation 11$$

In some aspects, the disclosed processes can enforce component spacing constraints by utilizing the macro halo technique. The halo can effectively enlarge the component footprint during placement, using a halo parameter to indicate the increase in size. For example, the halo parameter can be a percentage increase in each dimension of the component or set length increase (for example, 0.5 millimeters or other values). After placement and legalization, no components overlap, ensuring that spacing constraints are satisfied once the component footprints are reduced back to their original size.

In some aspects, a PCB benchmark suite is disclosed based on commercial designs to facilitate comparison between PCB placement tools and establish a meaningful baseline. The suite can consist of one or more sets of designs. For example, one set can be a small open-source set containing PCB designs with 2 to 500 components, a second set can be medium sized containing 501-2,000 components, and a third set can be large sized containing 2001−X components. Other groupings and size limitations can be utilized for the PCB placement benchmark.

In some aspects, consideration is given to how PCB engineers approach placement for larger designs. PCB engineers can start by performing local placement on a subset of component designs off-canvas, then position the group on the main board. These component groups can be chosen based on functionality, such as placing a general-purpose input/output (GPIO) expander alongside its connected components. Such practice makes small while realistic test cases are particularly important for the industry. Based on this observation, designs can be synthesized accommodating varying counts of components, pins, and nets. For example, the set of small PCB placement benchmarks can have synthesized designs to use as the benchmark as shown in Table 1. The benchmark data can include component shapes, layer assignments, pin positions, or net connections. These designs can be based on functional groups of commercial PCB designs, for example, Ethernet IC controllers, power controllers, GPIO expanders, or complex programmable logic devices (CPLDs). Table 1 also shows a set of large PCB placement benchmarks. Existing PCB placement tools typically cannot handle designs in the set of large PCB placement benchmarks.

TABLE 1
Example benchmarks that can be used, grouped by relative size

| PCB Placement | # of | # of | # of |
|---|---|---|---|
| Benchmark | components | pins | nets |
| Small-1 | 57 | 167 | 85 |
| Small-2 | 240 | 612 | 84 |
| Small-3 | 63 | 156 | 51 |
| Small-4 | 43 | 129 | 82 |
| Small-5 | 41 | 105 | 49 |
| Small-6 | 46 | 85 | 26 |
| Small-7 | 50 | 153 | 95 |
| Small-8 | 115 | 334 | 199 |
| Small-9 | 476 | 2,212 | 1,513 |
| Small-10 | 136 | 582 | 403 |
| Large-1 | 6,589 | 18,140 | 5,620 |
| Large-2 | 6,537 | 21,824 | 7,190 |
| Large-3 | 5,118 | 11,618 | 2,914 |
| Large-4 | 6,542 | 21,893 | 7,166 |
| Large-5 | 6,628 | 20,838 | 6,937 |

The PCB placement design can be evaluated using key metrics, such as a half-perimeter wirelength (HPWL) metric, a net crossing metric, a routability metric, or a routed track length metric. Industry tools can be used to evaluate the individual metrics. For the PCB placement design, the processes can initially assume that the board has two free copper layers for routing. This assumption can be modified through a user input parameter. Routability can be defined as the ratio of successfully routed pin pairs to the total number of pin pairs reported by a routing evaluation tool. In some aspects, PCB engineer placement designs can be incorporated as human baselines in the benchmark process. PCB engineer placement designs can take into consideration additional factors, such as thermal metric considerations. Therefore, engineer created designs often have a different layout than an automated process and have a lower wirelength performance parameter than the automated process.

The PCB benchmark process can be run for the one or more designs created by the disclosed processes. The output was then compared against a PCB engineer generated design, and three existing industry tools. NS-Place is an academic PCB placement tool that uses a net separation formulation to optimize routability by separating the convex hull of nets. SA-PCB is an open-source tool based on simulated annealing which supports double-sided designs and component rotation. The third tool is Quilter which is a commercial solution that employs reinforcement learning to automated PCB placement and routing. Table 2 shows the benchmarking output from a sample set of component designs that were submitted to each tool. In Table 2, the HPWL column denotes the half-perimeter wirelength where lower is better. The NC column represents the net crossings where lower is better. The RB column (e.g., routability) represents the routability where higher is better. The TL column (e.g., track length) represents the routed track length where lower is better. The Averages row represents the averages as normalized relative to the SA-PCB tool

TABLE 2
Example benchmark output using a sample set of component designs

| Benchmark | SA | | | | NS-Place | | | |
|---|---|---|---|---|---|---|---|---|
| Size | HPWL | NC | RB | TL | HPWL | NC | RB | TL |
| Small-1 | 18.2K | 122.34 | 100% | 1.4K | 7.9K | 82.09 | 60.8% | 0.4K |
| Small-2 | 92.6K | 172.95 | 100% | 9.0K | 15.4K | 6.04 | 54.9% | 0.6K |
| Small-3 | 11.0K | 80.98 | 99.0% | 1.2K | 3.3K | 60.44 | 93.0% | 0.7K |
| Small-4 | 12.9K | 8.17 | 100% | 0.9K | 4.8K | 0.58 | 17.8% | 0.1K |
| Small-5 | 6.0K | 23.36 | 91.0% | 0.6K | 2.3K | 16.94 | 71.8% | 0.3K |
| Small-6 | 5.5K | 56.21 | 98.3% | 0.5K | 3.5K | 31.33 | 86.4% | 0.5K |
| Small-7 | 11.4K | 20.74 | 96.6% | 0.6K | 6.9K | 10.52 | 58.0% | 0.1K |
| Small-8 | 118.3K | 33.97 | 82.9% | 8.4K | 44.0K | 31.55 | 63.1% | 2.7K |
| Small-9 | 1322.3K | 2164.66 | 98.6% | 23.8K | — | — | — | — |
| Small-10 | 131.1K | 123.75 | 81.5% | 7.8K | 66.6K | 105.89 | 27.1% | 1.1K |
| average | 1.0 | 1.0 | 1.0 | 1.0 | 0.1 | 0.14 | 0.62 | 0.13 |

| Benchmark | Quilter | | | | Human | | | |
|---|---|---|---|---|---|---|---|---|
| Size | HPWL | NC | RB | TL | HPWL | NC | RB | TL |
| Small-1 | 2.3K | 137.37 | 100% | 0.3K | 4.0K | 74.63 | 100% | 0.3K |
| Small-2 | 26.2K | 79.29 | 100% | 3.2K | 11.4K | 21.83 | 100% | 1.2K |
| Small-3 | 2.8K | 42.78 | 100% | 0.2K | 3.7K | 111.01 | 100% | 0.2K |
| Small-4 | 4.1K | 9.99 | 100% | 0.2K | 4.5K | 5.11 | 100% | 0.3K |
| Small-5 | 2.7K | 27.17 | 100% | 0.2K | 2.3K | 17.81 | 100% | 0.2K |
| Small-6 | 2.0K | 41.92 | 100% | 0.1K | 1.4K | 36.0 | 100% | 0.1K |
| Small-7 | 2.6K | 13.73 | 100% | 0.2K | 2.9K | 4.45 | 100% | 0.2K |
| Small-8 | 21.2K | 25.65 | 100% | 2.1K | 7.1K | 29.6 | 98.5% | 0.4K |
| Small-9 | — | — | — | — | 161.5K | 1911.83 | 90.4% | 7.0K |
| Small-10 | 25.9K | 102.04 | 100% | 2.0K | 16.4K | 164.56 | 100% | 1.0K |
| average | 0.06 | 0.19 | 1.05 | 0.18 | 0.12 | 0.85 | 1.04 | 0.2 |

| | |
|---|---|
| Benchmark | Disclosed Processes |

| Size | HPWL | NC | RB | TL |
|---|---|---|---|---|
| Small-1 | 1.6 | 46.51 | 100% | 0.2K |
| Small-2 | 6.5K | 36.12 | 100% | 1.1K |
| Small-3 | 1.7K | 52.89 | 100% | 0.2K |
| Small-4 | 1.8K | 6.2 | 100% | 0.2K |
| Small-5 | 1.5K | 20.1 | 100% | 0.2K |
| Small-6 | 0.9K | 18.4 | 100% | 0.1K |
| Small-7 | 0.7K | 18.71 | 100% | 0.1K |
| Small-8 | 3.7K | 9.66 | 100% | 0.4K |
| Small-9 | 25.0K | 809.31 | — | 3.5K |
| Small-10 | 8.4K | 84.56 | 100% | 0.5K |
| average | 0.03 | 0.39 | 1.05 | 0.12 |

Evaluating the benchmark outputs against the sample set of component designs submitted shows the disclosed processes outperform the previous tools. The design with the lowest HPWL was selected as the final design when a tool produced more than one design choice. Against SA-PCB, the disclosed processes improve HPWL by 75% to 98.1%, averaging 89.5%, and net crossing by 45.7% on average, with a maximum of 79.1%. Routability improves by 1.0-1.2×, and track length is 3.6-19.7× shorter. Compared to NS-Place, the disclosed processes improve HPWL by 69.3% on average, and net crossing varies from a 963% degradation to a 69.4% improvement. Routability improves by 2.2×. Against Quilter, the disclosed processes improve HPWL by 54.3% on average, and net crossing by 57.8%. Routability remains similar, except for S9, where Quilter failed, and the disclosed processes produced a fully routable design. Compared to human designers, the disclosed processes improve HPWL by 34.4-84.5%, with an average of 54.2%, while routability remains the same and track length decreases by 1.5×.

In some aspects, the disclosed processes can support various design constraints. In some aspects, the disclosed processes can handle height or alignment constraints. Height constraints (e.g., “keep-out” areas) can prevent tall components from certain regions, while alignment constraints can need specific components to be aligned with each other. These constraints can be considered through penalties in the objective function or through legalization, and preprocessing can merge aligned components into units during placement. In some aspects, critical components such as high current paths (e.g., a high current path constraint—such as when the required current for a component exceeds a threshold indicating that the component needs more energy than the typical components on the circuit board) or high-speed signals (e.g., a high-speed signal constraint—such as when the component can utilize a signal throughout that exceeds a threshold indicating that the component has a higher signal throughput than the typical component on the circuit board) can be accommodated. In some aspects, other constraints can be utilized, such as a thermal constraint, a mechanical constraint, or an electromagnetic constraint.

Turning now to the figures, FIG. 1 is an illustration of a diagram of example flow 100 to design a PCB. Flow 100 is a typically top-level PCB design process. Flow 100 begins with a start of a design process 110. Once the design has started for a PCB, the components are placed and electrical couplings routed between pins in a process 115. Checks are performed and simulations are performed to verify the design in a process 120. The design is finalized in the system in a process 125. The design can be reviewed off-line in a process 130 followed by a final check and a final review in a process 135. Optionally, a peer review can be conducted of the design in a process 140 before the final design is released for production in a process 145. The disclosed processes can replace process 115 and process 120 thereby decreasing the time to design the initial PCB and improving the design efficiency.

FIG. 2 is an illustration of a diagram of example net crossing 200. Net crossing 200 shows a multi-pin net as a set of line segments. Each line segment starts from the source pin and ends at the sink pin. The net crossing is then defined as the sum of pin pairs' line segment crossings. Net crossing 200 shows pin pairs 205. Pin pairs 205 has a source pin 210 and three sink pins, a sink pin 215, a sink pin 220, and a sink pin 225. A solid line 225 denotes the source to sink pairing from source pin 210 to sink pin 225. Solid lines are shown for sink pin 215 and sink pin 220 as well. A dashed line 230 denotes the net track from source pin 210 to sink pin 225. Additional dashed lines are shown for sink pin 215 and sink pin 220 as well.

Net crossing 200 also demonstrates a sample pin pair crossing 206. A source pin 250 is paired to a sink pin 254. A source pin 256 is paired to a sink pin 252. A line segment L₁ between source pin 250 and sink pin 254 crosses a line segment L₂ between source pin 256 and sink pin 252. Relative (x,y) values are shown for each pin as well.

FIG. 3 is an illustration of a diagram of an example net convex model 300. Some methods have used a concept similar to net crossing by separating the convex hulls of nets, resulting in a problem formulation that closely resembles a support vector machine (SVM). The net convex hull model can be too restrictive. No overlap between convex hulls implies zero net crossings which can be less accurate than the disclosed net crossing model. The two nets are represented as a pin pair model 310 and a convex hull model 320. When calculating the NC of pin pair model 310, the result is zero. This is accurate since the two nets do not have a routing resource conflict. In convex hull model 320, overlap between a convex hull 330 (solid line triangle) and a convex hull 335 (dotted line triangle) can indicate a routing conflict, which can be inaccurate. The disclosed pin pair-based approach better reflects how routers can handle nets in a PCB design.

FIG. 4 is an illustration of a diagram of an example of a VLSI placement model 400. In VLSI placement, the RUDY model is widely used to estimate routing congestion, a typical proxy for routability. RUDY is calculated based on the available routing resources in a routing g-cell and its overlap with the net's bounding box. This model works well for VLSI routing because VLSI designs have grid-based rectilinear routing systems with many metal layers, and routers generally aim to route each net within the bounding box enclosing its pins. Multi-pin nets are also routed with a tree, and not independent source-sink connections. Thus, RUDY is less effective for PCBs, which have fewer metal layers, and where the specific connections between pin pairs play a much larger role and can be realized with more freedom, i.e., no grid and possible angled routing.

VLSI placement model 400 illustrates this using two example cases with identical routing congestion RUDY scores. A model 410 has a source pin 420 and a source pin 422. Source pin 422 is used to define a bounding box 427 (solid line box). Source pin 420 is used to define a bounding box 425 (dotted line box). Model 410 does not have a routing conflict. A model 430 has a source pin 432 and a source pin 434. Source pin 432 is used to define a bounding box 442 (dotted line box). Source pin 434 is used to define a bounding box 440 (solid line box). Model 430 does have a routing conflict. Since they have the same RUDY congestion score, RUDY can be a flawed model for PCB routability.

FIG. 5 is an illustration of a diagram of an example graph 500 showing a relative scalability performance of the disclosed processes and selected industry tools. Graph 500 illustrates the relationship between the number of components (shown on a x-axis 505) in the design and the run time (shown on a y-axis 506). The run time of SA-PCB can increase linearly with component count as shown by line 520. Quilter can grow exponentially with component count, as shown by line 522. Quilter's longer run time can be attributed to two factors: its reinforcement learning approach, which relies on a sample learning process, and that it includes routing within the optimization cycle.

Although NS-Place exhibits good scalability, as shown by line 524, it can fail at its mixed integer linear programming (MILP) legalization stage, which can be a large run time bottleneck. NS-Place shows a short runtime in this example. This is due to the failure of the most time-consuming MILP legalization stage to find a legal solution. The disclosed processes exhibit strong scalability, as shown by line 526. The scalability can be enhanced by using acceleration, such as GPU acceleration. The reported run times of graph 500 reflects the time for a placement job, not the full run time.

FIG. 6 is an illustration of a diagram of example design solutions 600 produced by the tested tools. A SA-PCB PCB design 610 focuses on avoiding component overlap and minimizing wirelength. Due to an improper balance between these objectives, it can often push components to the borders. While this can improve routability for smaller designs, this approach can degrade routability on a larger and denser design.

An NS-Place PCB design 612 can optimize routability by minimizing the overlaps between the net convex hulls, a conservative while less precise model than net crossing. Although this can be efficient for avoiding net crossings, the over constraining while avoiding proper balance with density and wirelength can lead to weirdly arranged solutions where small components cluster into non-overlapping convex hulls, causing blockages and reducing routability. Furthermore, NS-Place can depend on legalization to resolve overlaps, leading to substantial deviations between global and detailed placement stages, thus producing unpredictable results. The MILP-based legalization approach, moreover, can lack scalability and can fail, leaving the final solution with unresolved overlaps.

A Quilter PCB design 614, a closed-source commercial placer, can integrate a router in the optimization loop, yielding highly routable designs. This comes at the cost of long run times and limited scalability. The disclosed process PCB design 616 highlights the significance of multi-objective optimization. By considering wirelength, net crossing, and density simultaneously, the disclosed processes can consistently produce highly routable designs.

FIG. 7 is an illustration of a flow diagram of an example method 700 to use a PCB design process. Method 700 can be performed on a computing system, for example, PCB design system 900 of FIG. 9 or PCB design controller 1000 of FIG. 10. The computing system can be one or more processors in various combinations (e.g., CPUs, GPUs, SIMDs, or other types of processors), a data center, a cloud environment, a server, a laptop, a mobile device, a smartphone, a PDA, or other computing system capable of compiling code for a targeted processing unit. Method 700 can be encapsulated in software code or in hardware, for example, an application, code library, code module, dynamic link library, module, function, RAM, ROM module, and other software and hardware implementations. The software can be stored in a file, database, or other computing system storage mechanism. Method 700 can be partially implemented in software and partially in hardware. Method 700 can perform the steps for the described processes, for example, determining a PCB design from a set of component designs and constraints that are provided as input parameters.

Method 700 starts at a step 705 and proceeds to a step 710. In step 710, a set of component designs can be received. The set of component designs are the components that are to be arranged on a PCB. The PCB can be two-sided for placement purposes. Other received input parameters can be the size of the PCB or the shape of the PCB, e.g., trapezoid, rectangle, square, or other geometric shapes whether regular or irregular shaped. In some aspects, the set of component designs can include parameters specific to one or more components. For example, one or more components can have an orientation parameter describing the orientation of the component on the PCB. A parameter can describe a constraint of the component, for example, a minimum thermal dispersion parameter, a height parameter, or other size parameter. A parameter can describe how to group a subset of component designs in the set of component designs, for example, when two or more components should be placed close to each other on the PCB. A parameter can set a location on the PCB for a component (e.g., pre-determined placement), for example, an external connector component should be placed near an edge of the PCB, or a component requiring thermal dispersion can be placed in a location where thermal transfer components are located. A parameter can specify an orientation for one or more components in the set of component designs. A design threshold parameter can be received to describe the qualifications to satisfy the design threshold. A parameter can include one or more pre-routed traces that are used as placement blockages when generating the PCB design.

In a step 715, the process will begin the iterative process to place each component design in the set of component designs. Using the input parameters and specified constraints, the process will start with placing components that have a specific location. Steps 720 through 740 are then used within the iterative process to complete the placement of the remaining components.

In a step 720, a wire path from each source pin to the appropriate sink pin is determined. A wire path between each pin of each component design in the set of component designs and an intended corresponding electrically coupled pin of a different component in the set of component designs using a coupling policy received as input parameters can be determined.

In a step 725, the HPWL parameter is calculated for each wire path. In a step 730, the NC parameter is calculated for each wire path. In a step 735, the density parameter is calculated for the components placed on the PCB. In a step 740, the HPWL parameter, the NC parameter, and the density parameter are used as inputs to the iterative cost function calculation. The iterative cost function result can indicate how efficient the design of the component placement is. A design that does not satisfy the design threshold will cause method 700 to return to step 715 to reevaluate the placement process (e.g., repeating the iterative cost function with the new component placement). In some aspects, the random parameters generated previously can be regenerated. In some aspects, the weight of the density parameter can be adjusted. In some aspects, the weight of the NC parameter can be adjusted. These adjustments can be made prior to beginning a subsequent iteration of the placement process. In some aspects, a different weight is used for at least one tunnable parameter of the iterative cost function. If the design threshold is satisfied (e.g., the iterative cost function ends), then method 700 proceeds to a step 745.

In step 745, the determined PCB design can be communicated to a user, a data store, or another processing system. The PCB design can then undergo an optional subsequent design review. The PCB design can then be used as a blueprint for a manufacturing process, for example, manufacturing the PCB using the PCB design. Method 700 ends at a step 795.

FIG. 8 is an illustration of a flow diagram of an example method 800 to evaluate a PCB design. Method 800 can be performed on a computing system, for example, PCB design system 900 of FIG. 9 or PCB design controller 1000 of FIG. 10. The computing system can be one or more processors in various combinations (e.g., CPUs, GPUs, SIMDs, or other types of processors), a data center, a cloud environment, a server, a laptop, a mobile device, a smartphone, a PDA, or other computing system capable of compiling code for a targeted processing unit. Method 800 can be encapsulated in software code or in hardware, for example, an application, code library, code module, dynamic link library, module, function, RAM, ROM module, and other software and hardware implementations. The software can be stored in a file, database, or other computing system storage mechanism. Method 800 can be partially implemented in software and partially in hardware. Method 800 can perform the steps for the described processes, for example, evaluating a PCB design using one or more evaluation processes.

Method 800 can be performed during the evaluation of the design threshold of the PCB design in step 740 of method 700. A PCB design can satisfy the HPWL parameters, the NC parameters, and the density parameters, and then subsequently be evaluated against a design efficiency parameter. If the design efficiency parameter is satisfied, then method 700 can proceed to step 745. If the design efficiency parameter is not satisfied, then the design threshold can be designated as not being satisfied and method 700 proceeds back to step 715 as specified in step 740. Method 800 performs the design efficiency parameter evaluation starting at a step 805.

Proceeding to a step 810, an evaluation tool can be determined to be used to perform the comparison and evaluation. In some aspects, the evaluation tool can be an open-source tool. In some aspects, the evaluation tool can be a proprietary tool. In some aspects, the evaluation tool is capable of handling a similar number of components and similar types of components as specified in the set of component designs.

In a step 815, the evaluation tool can be initialized with input parameters allowing the evaluation tool to analyze the PCB design. For example, the evaluation tool can be initialized with a range of the number of components as specified in the set of component designs. In some aspects, the evaluation tool can be initialized with similar types of components as specified in the set of component designs. The initialization can allow the evaluation tool to better analyze the PCB design using metrics that align with the PCB design.

In a step 820, the PCB design can be evaluated using the evaluation tool. The evaluation tool can utilize one or more metrics that can be analyzed to produce metric results. In some aspects, an HPWL metric can be used to determine the efficiency of the HPWL parameters. In some aspects, an NC metric can be used to determine the efficiency of the NC parameters. In some aspects, a routability metric can be used to determine the efficiency of the PCB design routability. In some aspects, a thermal metric can be used to determine the efficiency of the PCB design thermal profile. In some aspects, a routed track length metric can be used to determine the efficiency of the PCB design track length. Other metrics can be utilized as well.

In a step 825, the metric results for each metric evaluated can be used to determine whether or not the design threshold result should be updated. For example, if an NC metric is unsatisfactory, then the design threshold is updated to be unsatisfied as well. In some aspects, each metric used can be weighted differently from other metrics used. The metrics used and their respective weightings can be specified in the input parameters. Method 800 ends at a step 895, returning to step 740 of method 700.

FIG. 9 is an illustration of a block diagram of an example PCB design system 900. PCB design system 900 can be implemented in one or more computing systems or one or more processors. In some aspects, PCB design system 900 can be implemented using a PCB design controller such as PCB design controller 1000 of FIG. 10. PCB design system 900 can implement one or more aspects of this disclosure, such as method 700 of FIG. 7 or method 800 of FIG. 8.

PCB design system 900, or a portion thereof, can be implemented as an application, a code library, a dynamic link library, a function, a module, a header file, other software implementation, or combinations thereof. In some aspects, PCB design system 900 can be implemented in hardware, such as a ROM, a graphics processing unit, or other hardware implementation. In some aspects, PCB design system 900 can be implemented partially as a software application and partially as a hardware implementation. PCB design system 900 is a functional view of the disclosed processes and an implementation can combine or separate the described functions in one or more software or hardware systems.

PCB design system 900 includes a data transceiver 910, a PCB design processor 920, and a result transceiver 930. The output, e.g., the result, can be communicated to a data receiver, such as one or more of a user 960, one or more computing systems 962, or one or more storage devices 964. In some aspects, the one or more computing systems 962 can be a chip manufacturing machine, for example, to manufacture the PCB using the PCB design.

In some aspects, the results of the PCB design system 900, such as those communicated to the one or more users 960, one or more storage devices 964, or one or more computing systems 962, can be used as an input into another process or system, for example, being used as an input to other PCB manufacturing operations.

Data transceiver 910 can receive the input parameters, including the set of component designs, and one or more input parameters, including PCB design parameters, constraints, evaluation tools, threshold parameters, metrics, metric weightings and other input parameters. In some aspects, data transceiver 910 can be part of PCB design processor 920.

Result transceiver 930 can communicate one or more outputs, to one or more receivers, such as users 960, one or more computing systems 962, one or more storage devices 964, or other related systems, whether located proximate result transceiver 930 or distant from result transceiver 930. Data transceiver 910, PCB design processor 920, and result transceiver 930 can be, or can include, conventional interfaces configured for transmitting and receiving data. Data transceiver 910, PCB design processor 920, or result transceiver 930 can be implemented as software components, for example, a virtual processor environment, as hardware, for example, circuits of an integrated circuit, or combinations of software and hardware components and functionality. The functionality described for these components remains intact regardless of how the functionality is implemented.

PCB design processor 920 (e.g., one or more combinations of processor units or processing cores such as processor 1030 of FIG. 10) can implement the analysis and algorithms as described herein utilizing the input parameters and set of component designs. PCB design processor 920 can be one or more of a dedicated hardware component, a PCB design unit, a multicore processor, a multiprocessor system, processors located on one or more systems, or a streaming multiprocessor. PCB design processor 920 can be implemented by one or more of a central processing unit (CPU), a graphics processing unit (GPU), or other types of processors. PCB design processor 920 can be a component placement system, a benchmark system, or a combination thereof.

A memory or data storage system of PCB design processor 920 can be configured to store the processes and algorithms for directing the operation of PCB design processor 920. PCB design processor 920 can include a processor that is configured to operate according to the analysis operations and algorithms disclosed herein, and an interface to communicate (transmit and receive) data. PCB design processor 920 can implement a computer program product having a series of operating instructions stored on a non-transitory computer-readable medium that directs the PCB design process when executed thereby to perform the disclosed operations, for example, as specified in method 700 or method 800.

FIG. 10 is an illustration of a block diagram of an example of a PCB design controller 1000 according to the principles of the disclosure. PCB design controller 1000 can be stored on one computer or multiple computers. The various components of PCB design controller 1000 can communicate via wireless or wired conventional connections. A portion or a whole of PCB design controller 1000 can be located at one or more locations. In some aspects, PCB design controller 1000 can be part of another system (e.g., processor, core, server, or other systems), and can be integrated with one device, such as a part of a processing system. PCB design controller 1000 represents a demonstration of the functionality employed for the disclosure, and implementations can use a variety of devices, for example, circuits of a processor, dedicated processors, virtual systems, servers, other computing or processing systems, be in software or hardware, or various combinations thereof.

PCB design controller 1000 can be configured to perform the various functions disclosed herein including receiving input parameters and sets of components, and generating results from execution of the methods and processes described herein, such as generating a final result representing the PCB design and the design threshold and design efficiency parameters. PCB design controller 1000 includes a communications interface 1010, a memory 1020, and a processor 1030.

Communications interface 1010 is configured to transmit and receive data. For example, communications interface 1010 can receive the input parameters. Communications interface 1010 can transmit the output or interim outputs. In some aspects, communications interface 1010 can transmit a status, such as a success or failure indicator of PCB design controller 1000 regarding receiving the various inputs, transmitting the generated outputs, or producing the results.

In some aspects, processor 1030 can perform the operations as described by PCB design processor 920. Communications interface 1010 can communicate via communication systems used in the industry. For example, wireless or wired protocols can be used. Communication interface 1010 is capable of performing the operations as described for data transceiver 910 and result transceiver 930 of FIG. 9.

Memory 1020 can be configured to store a series of operating instructions that direct the operation of processor 1030 when initiated, including supporting code representing the algorithm for implementing the PCB design process instruction. Memory 1020 is a non-transitory computer-readable medium. Multiple types of memory can be used for the data storage systems and memory 1020 can be distributed.

Processor 1030 can be one or more processors. Processor 1030 can be a combination of processor types, such as a CPU, a GPU, a single instruction multiple data (SIMD) processor, or other processor types. Processor 1030 can be a PCB design unit. Processor 1030 can be a virtual process supported by a processing unit. Processor 1030 can be configured to produce the output, one or more interim outputs, and statuses utilizing the received inputs. Processor 1030 can determine the output using parallel processing. Processor 1030 can be an integrated circuit. In some aspects, processor 1030, communications interface 1010, memory 1020, or various combinations thereof, can be an integrated circuit. Processor 1030 can be configured to direct the operation of PCB design controller 1000. Processor 1030 includes the logic to communicate with communications interface 1010 and memory 1020, and performs the functions described herein. Processor 1030 is capable of performing or directing the operations as described by PCB design processor 920 of FIG. 9, such as implementing a component placement system or a benchmark system.

In some aspects, PCB design system 900 or PCB design controller 1000 can be part of a machine learning system. The machine learning system can use as input the input parameters and set of component designs, and the output can be a PCB design. The machine learning system can be trained using existing commercial PCB designs. The machine learning system can be trained using existing PCB design tools in combination with the evaluation metrics. The machine learning system can include the evaluation design process, so the PCB design satisfies the design threshold and specified metrics.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
receiving a set of component designs to be arranged on a printed circuit board (PCB), wherein each component design in the set of component designs is an electronic component that is intended to be electrically coupled to at least one other component in the set of component designs and includes a count of pins for the each component design; and
designating a placement for each component design in the set of component designs on the PCB using an iterative cost function to generate a PCB design, wherein the iterative cost function includes:
determining a wire path between each pin of each component design in the set of component designs and a corresponding electrically coupled pin of a different component in the set of component designs using a coupling policy received as input parameters;
calculating a half-perimeter wirelength (HPWL) parameter for the set of component designs;
calculating a net crossing (NC) parameter for the set of component designs;
calculating a density parameter for the set of component designs; and
evaluating the iterative cost function using the HPWL parameter, the NC parameter, and the density parameter, wherein the iterative cost function ends at a time specified by an end parameter received with the input parameters or when a result of the iterative cost function satisfies a design threshold parameter, wherein the design threshold parameter is received in the input parameters.

2. The method as recited in claim 1, further comprising:
manufacturing the PCB using the PCB design.

3. The method as recited in claim 1, wherein the PCB supports arrangement of the set of component designs on more than one side of the PCB, where a separate density map is calculated for each side of the PCB.

4. The method as recited in claim 1, wherein the calculating the HPWL utilizes a permissible orientation parameter of each component design in the set of component designs.

5. The method as recited in claim 1, wherein the designating the placement for each component design further utilizes a scalability function.

6. The method as recited in claim 1, wherein the receiving includes a PCB netlist specifying a pre-assigned layer for one or more components in the set of component designs.

7. The method as recited in claim 1, wherein the receiving includes a pre-determined placement for one or more components in the set of component designs.

8. The method as recited in claim 1, wherein the receiving includes one or more pre-routed traces that are used as placement blockages when generating the PCB design.

9. The method as recited in claim 1, wherein the calculating the NC increases a weight of a net crossing term as components in the set of component designs are distributed and arranged on the PCB design.

10. The method as recited in claim 1, wherein the designating the placement further utilizes a divergence-aware gradient preconditioning using a pin count of each component design in the set of component designs to estimate a second-order derivative of the HPWL parameter, and an area of each component design in the set of component designs to estimate a second-order derivative of the density parameter.

11. The method as recited in claim 1, wherein the designating the placement utilizes a halo parameter for each component design in the set of component designs to indicate an increase in a size parameter of each component design.

12. The method as recited in claim 1, wherein the designating a placement utilizes design constraints, where the design constraints are one or more of a height constraint, an alignment constraint, a current path constraint, or a thermal constraint.

13. The method as recited in claim 1, wherein the designating a placement for each component design is repeated using a different weight for at least one tunnable parameter of the iterative cost function.

14. The method as recited in claim 1, wherein the designating a placement for each component design is repeated using different independent and identically distributed random values when determining a relaxation of a permissible orientation of at least one component in the set of component designs.

15. The method as recited in claim 1, further comprising:
evaluating the PCB design using an evaluation tool to generate a design efficiency parameter, wherein the designating a placement for each component design is repeated when the design efficiency parameter fails to meet the design threshold.

16. The method as recited in claim 15, wherein the evaluation tool is an open-source PCB placement benchmark.

17. The method as recited in claim 15, wherein the evaluation tool uses existing commercial PCB designs that use a count of components within a range, where the range includes a count of components in the set of component designs.

18. The method as recited in claim 15, wherein the evaluating the PCB design utilizes one or more of an HPWL metric, an NC metric, a routability metric, a thermal metric, or a routed track length metric.

19. A system, comprising:
a component placement system capable to designate a placement of each component design in a set of component designs using an iterative cost function to generate a PCB design, wherein the iterative cost function determines a wire path between each pin of each component design in the set of component designs and an intended corresponding electrically coupled pin of a different component in the set of component designs using a coupling policy received as input parameters, calculates a half-perimeter wirelength parameter (HPWL) for the set of component designs, calculates a net crossing parameter (NC) for the set of component designs, calculates a density parameter for the set of component designs, and evaluates the iterative cost function using the HPWL parameter, the NC parameter, and the density parameter, where the iterative cost function ends at a time specified by an end parameter received with the input parameters or when a result of the iterative cost function satisfies a design threshold parameter; and
a benchmark system capable to evaluate the PCB design using an evaluation tool to generate a design efficiency parameter, wherein the designate a placement for each component design is repeated when the design efficiency parameter fails to meet the design threshold.

20. The system as recited in claim 19, wherein one or more of the component placement system or the benchmark system is a central processing unit (CPU), a graphics processing unit (GPU), or a single instruction multiple data (SIMD) processing unit.

21. The system as recited in claim 19, wherein the benchmark system utilizes one or more of a HPWL metric, a NC metric, a routability metric, a thermal metric, or a routed track length metric.

22. A non-transitory computer program product having a series of operating instructions stored on a non-transitory computer-readable medium that directs a PCB design process when executed thereby to perform operations, the operations comprising:
receiving a set of component designs to be arranged on a printed circuit board (PCB), wherein each component design in the set of component designs is an electronic component that is intended to be electrically coupled to at least one other component in the set of component designs and includes a count of pins for the component;
designating a placement for each component design in the set of component designs on the PCB using an iterative cost function to generate a PCB design, wherein the iterative cost function includes:
determining a wire path between each pin of each component design in the set of component designs and a corresponding electrically coupled pin of a different component in the set of component designs using a coupling policy received as input parameters;
calculating a half-perimeter wirelength parameter (HPWL) for the set of component designs;
calculating a net crossing parameter (NC) for the set of component designs;
calculating a density parameter for the set of component designs; and
evaluating the iterative cost function using the HPWL parameter, the NC parameter, and the density parameter, wherein the iterative cost function ends at a time specified by an end parameter received with the input parameters or when a result of the iterative cost function satisfies a design threshold parameter, wherein the design threshold parameter is received in the input parameters; and
manufacturing the PCB using the design.

23. The non-transitory computer program product as recited in claim 22, further comprising:
evaluating the PCB design using an evaluation tool to generate a design efficiency parameter, wherein the designating a placement for each component design is repeated when the design efficiency parameter fails to meet the design threshold.

24. A processing unit, comprising:
a PCB design system, capable of designating a placement of each component design in a set of component designs using an iterative cost function to generate a PCB design, wherein the iterative cost function determines a wire path between each pin of each component design in the set of component designs and an intended corresponding electrically coupled pin of a different component in the set of component designs using a coupling policy received as input parameters, calculates a half-perimeter wirelength parameter (HPWL) for the set of component designs, calculates a net crossing parameter (NC) for the set of component designs, calculates a density parameter for the set of component designs, and evaluates the iterative cost function using the HPWL parameter, the NC parameter, and the density parameter, where the iterative cost function ends at a time specified by an end parameter received with the input parameters or when a result of the iterative cost function satisfies a design threshold parameter; and
a benchmark system, capable of evaluating the PCB design using an evaluation tool to generate a design efficiency parameter, wherein the designating a placement for each component design is repeated when the design efficiency parameter fails to meet the design threshold.

25. The processing unit as recited in claim 24, wherein the processing unit is graphics processing unit (GPU).
